(19) United States
(12) Patent Application Publication
(10) Pub. No.: US 2008/0057444 A1
(43) Pub. Date: Mar. 6, 2008

(54) Method of manufacturing a broad stamper

(75) Inventors: Seung-Hyun Ra, Seongnam-si (KR); Choon-Keun Lee, Suwon-si (KR); Sang-Moon Kee, Seoul (KR); Jae-Choon Cho, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/896,104

(22) Filed: Aug. 29, 2007

(30) Foreign Application Priority Data
Aug. 31, 2006 (KR) 10-2006-0083311

(51) Int. Cl. G03C 5/00

(52) U.S. Cl. 430/322

(57) ABSTRACT

A method of manufacturing a broad stamper is disclosed. Using a method that includes: stacking a first mask, in which a first pattern is perforated, on a positive photoresist layer; exposing an upper surface of the first mask to light; developing the positive photoresist layer to form an intaglio; and molding such that a relievo is formed, which is in correspondence with the intaglio, a broad stamper having multiple levels can be manufactured with a simple process.

### CROSS-REFERENCE TO RELATED APPLICATIONS

This application claims the benefit of Korean Patent Application No. 10-2006-0083311 filed with the Korean Intellectual Property Office on Aug. 31, 2006, the disclosure of which is incorporated herein by reference in its entirety.

### BACKGROUND

1. Technical Field

The present invention relates to a method of manufacturing a stamper, more particularly to a method of manufacturing a broad stamper in which the same patterns are repeated.

2. Description of the Related Art

In step with the societal demands of the twenty first century for high-tech information and communication, electronics and electrical technology has seen rapid advances towards greater storage capacities, faster information processing and transmission, and more convenient information communication networks.

In particular, under the condition of finiteness in information transmission speeds, the method is being suggested of generating new functionalities by implementing the components to be as small as possible while increasing reliability, as a way to meet such requirements.

As described above, with the trends towards lighter, thinner, and simpler electronic products, so also is the printed circuit board trending towards finer patterns, smaller sizes, and more packaged products. Thus, in order to implement circuits having greater signal processing capabilities in a narrower area, there is a need for manufacturing high-density boards (e.g. line/space≦10 μm/10 μm, microvia<30 μm).

One of the most widely used technology for fabricating minute structures is UV lithography, which is a method of irradiating ultraviolet rays on a board coated with a photoresist thin film to form circuit patterns.

However, manufacturing a board using the UV lithography method may have the limitations that the copper foil must be thick and that wet etching must be used, whereby the reliability of the products may be degraded when using UV lithography to form fine patterns with a pitch of 10 μm or less.

Recent times are seeing printed circuit boards with greater levels of integration, and accordingly, there is active ongoing research on methods of forming fine patterns. Thus, much attention is being given to attempts at manufacturing high-density boards using a stamper for forming circuit patterns, as an alternative process to the UV lithography method described above.

A stamper is commonly fabricated by nickel electroforming or by polymer molding, and in order to manufacture a stamper using such methods, a master mold may be required that has the desired patterns formed in intaglio.

The master mold may be made by etching processes applied on silicon (Si) wafers, etc., where the maximum area of a stamper would be limited to the size of the wafer. One method of using a small stamper to form circuit patterns having repeating patterns is to use UV-setting resin. The so-called “step & repeat” technique includes imprinting a stamper in a resin to form a pattern, irradiating UV rays to cure the resin, and then repeating the same procedures for the next section. This, however, may lead to long processing times.

Another technique is to imprint a stamper in thermosetting resin, but in this case, the imprint processing area relies entirely on the area of the stamper used.

For ultrafine (nanosized) patterns, it is possible to use processing methods that utilize electron beams or FIB's (focused ion beams), etc., but these entail excessively long processing times and high costs.

As such, there may be substantial limitations in terms of time and cost, in manufacturing a broad stamper having ultrafine patterns using existing methods.

### SUMMARY

An aspect of the invention is to provide a method of manufacturing a broad stamper having ultrafine patterns with a simple process.

One aspect of the claimed invention provides a method of manufacturing a broad stamper, which includes: stacking a first mask, in which a first pattern is perforated, on a positive photoresist layer; exposing an upper surface of the first mask to light; developing the positive photoresist layer to form an intaglio; and molding such that a relievo is formed, which is in correspondence with the intaglio.

After removing the first mask, between the exposing and the developing, those procedures may additionally be performed of stacking a second mask, in which a second pattern is formed; exposing an upper surface of the second mask to light; and removing the second mask. If a plurality of masks are used, a broad stamper may be manufactured that has multiple levels.

In this case, the second pattern may have a width smaller than that of the first pattern. This is so that a first exposure portion formed by the first pattern will not be affected by the exposure to light of the upper surface of the second mask.

The molding may be performed by any one of nickel electroforming and polymer molding. Nickel and polymers may be suitable molding materials, as they are easy to handle.

Also, an operation of curing the positive photoresist may further be included between the developing and the molding. In order to proceed with a molding process, the positive photoresist layer may require a certain degree of hardness. Thus, the molding may be performed after proceeding with this curing process.

After the molding, the broad stamper may be completed when the positive photoresist layer is removed.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flowchart of a process for manufacturing a broad stamper according to an embodiment of the invention.

FIG. 2 is a flow diagram of a process for manufacturing a broad stamper according to an embodiment of the invention.

### DETAILED DESCRIPTION

The method of manufacturing a broad stamper according to certain embodiments of the invention will be described below in more detail with reference to the accompanying drawings, in which those components are rendered the same reference numeral that are the same or are in correspondence, regardless of the figure number, and redundant explanations are omitted.

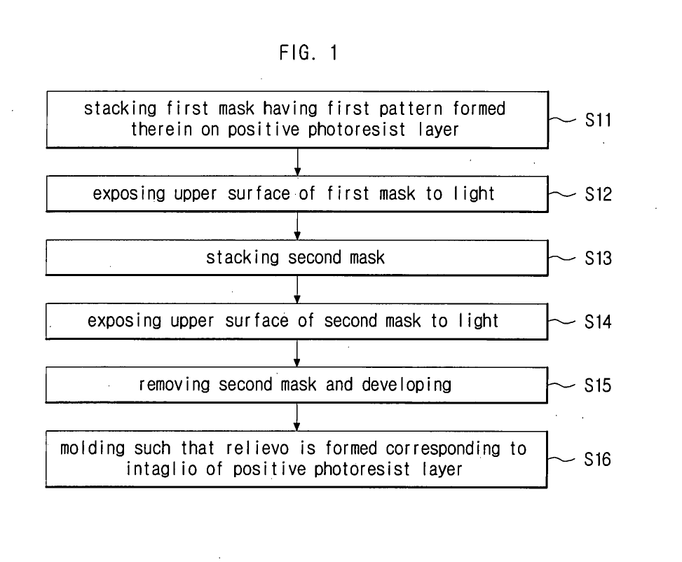

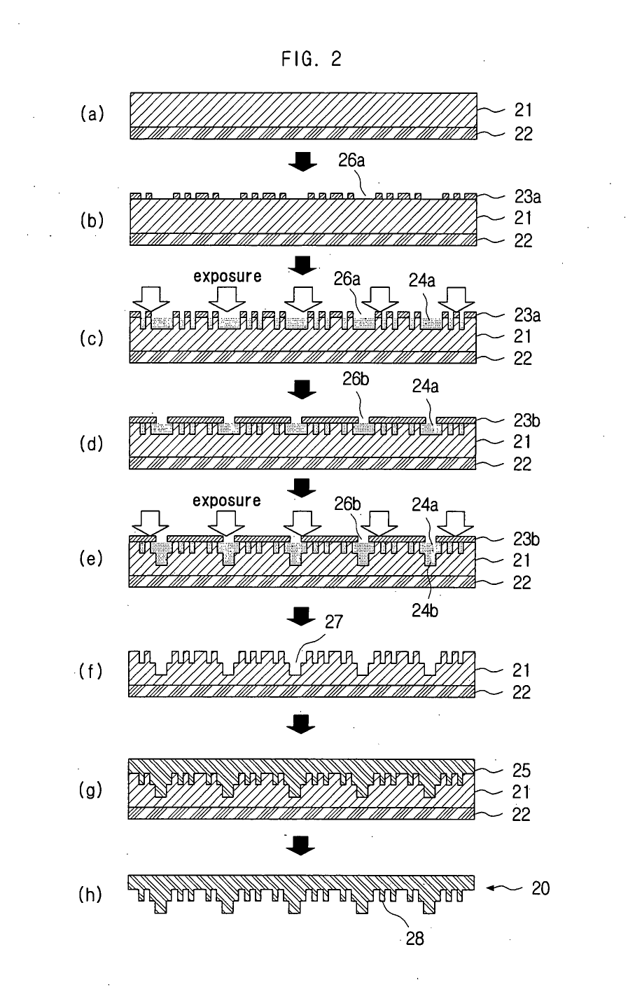

FIG. 1 is a flowchart of a process for manufacturing a broad stamper according to an embodiment of the invention, and FIG. 2 is a flow diagram of a process for manufacturing a broad stamper according to an embodiment of the invention. In FIG. 2 are illustrated a broad stamper 20, a positive photoresist layer 21, a substrate 22, a first mask 23a, a second mask 23b, a first exposure portion 24a, a second exposure portion 24b, a molding portion 25, a first pattern 26a, a second pattern 26b, an intaglio 27, and a relievo 28.

Operation S11 of FIG. 1 may be to stack the first mask 23a, in which the first pattern 26a is formed, on the positive photoresist layer 21, where drawings (a) and (b) of FIG. 2 represent processes related to this operation.

The positive photoresist layer 21 refers to the part where the portions exposed to light are removed, and the positive photoresist layer 21 of this embodiment, in particular, may have a property that those portions exposed to light become transparent.

The first pattern 26a may be formed in the first mask 23a. The first pattern 26a may be the portion where the first mask 23a is perforated. The first pattern 26a of the first mask 23a may determine the position where a circuit pattern will be formed later on.

Since the positive photoresist layer 21 by itself may be lacking in strength, the positive photoresist layer 21 may be stacked on the substrate 22, which will support the positive photoresist layer 21, before proceeding with the process. While the material for the substrate may be glass, quartz, or silicon, etc., it is not thus limited, and other materials may be used, such as metallic materials.

Operation S12 of FIG. 1 may be to expose the upper surface of the first mask 23a to light, where drawing (c) of FIG. 2 represents a process related to this operation. As illustrated in (c) of FIG. 2, when UV rays are irradiated, the portion of the positive photoresist layer 21 receiving the rays may become transparent. This portion will hereinafter be referred to as the “first exposure portion.” The first exposure portion 24a is the portion that will be removed later on. In order to form a pattern of multiple levels, it may be necessary to adjust the thickness of the first exposure portion 24a, where the adjusting method may include adjusting the intensity and time of light exposure.

Operation S13 of FIG. 1 may be to stack the second mask 23b, where drawing (d) of FIG. 2 represents a process related to this operation. While it may be considered to remove the first mask 23a before operation S13, the operation may be proceeded without removing the first mask 23a. The reason for proceeding with such an operation may be to form a multi-level intaglio 27 in the positive photoresist layer 21.

When the second mask 23b is stacked as in (d) of FIG. 2, the second pattern 26b of the second mask 23b may have a size smaller than that of the first pattern 26a in the first mask 23a. This is so that the first exposure portion 24a formed by the first pattern 26a will not be affected by the exposure to light for the second pattern 26b. In other words, as the second pattern 26b may be for forming an intaglio 27 with a greater depth, it may not be desirable to distort the first exposure portion 24a.

Operation S14 of FIG. 1 may be to expose the upper surface of the second mask 23b to light, where drawing (e) of FIG. 2 represents a process related to this operation. When the exposure is proceeded with as in (e) of FIG. 2, the second exposure portion 24b may be formed. Since the positive photoresist layer 21 may change to a transparent substance when exposed to light, the irradiated UV rays may be transmitted through the transparent first exposure portion 24a to form the second exposure portion 24b. As the size of the second pattern 26b may be smaller than the size of the first pattern 26a, the first exposure portion 24a and second exposure portion 24b form a multi-leveled configuration.

Operation S15 of FIG. 1 may be to remove and develop the second mask 23b. The portions of the positive photoresist layer 21 exposed to light may be developed, so that the developing process may remove the first exposure portion 24a and second exposure portion 24b. Consequently, a positive photoresist layer 21 may be obtained in which an intaglio 27 is formed, as in (g) of FIG. 2.

Operation S16 of FIG. 1 may be of molding such that the relievo 28 is formed which corresponds to the intaglio 27 of the positive photoresist layer 21, where drawing (g) of FIG. 2 represents a process related to this operation.

A procedure of curing the positive photoresist layer 21 may also be performed before operation S16. The positive photoresist layer 21 may have a generally low strength, and may thus be unsuitable for molding work. Therefore, by performing such a curing process, the molding work of operation S16 may be facilitated.

The molding may be performed using nickel electroforming or using polymers. However, other materials may just as well be used, as long as they ensure a certain degree of hardness and reliability in use in a stamper.

With the removal of the positive photoresist layer 21 and the substrate 22, the broad stamper 20 may be completed. The broad stamper 20 may have the relievo 28 formed therein. This relievo 28 may have a form that is in correspondence with the intaglio 27 of the positive photoresist layer 21.

According to a certain aspect of the claimed invention as set forth above, a broad stamper having multiple levels can be manufactured with a simple process, by using a positive photoresist layer and a plurality of masks in which patterns are formed.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method of manufacturing a broad stamper, the method comprising:
stacking a first mask on a positive photoresist layer, the first mask having a first pattern perforated therein;
exposing an upper surface of the first mask to light;
developing the positive photoresist layer to form an intaglio; and
molding such that a relievo is formed, the relievo being in correspondence with the intaglio.

2. The method of claim 1, further comprising, between the exposing and the developing:
stacking a second mask having a second pattern formed therein;
exposing an upper surface of the second mask to light; and
removing the second mask.

3. The method of claim 2, wherein the second pattern has a width smaller than that of the first pattern.

4. The method of claim 2, further comprising, before the stacking of the second mask:
removing the first mask.

5. The method of claim 1, wherein the molding is performed by any one of nickel electroforming and polymer molding.

6. The method of claim 1, further comprising, between the developing and the molding:
curing the positive photoresist.

7. The method of claim 1, further comprising, after the molding:
removing the positive photoresist layer.
